(19) United States
(12) Patent Application Publication
(10) Pub. No.: US 2015/0043766 A1
(43) Pub. Date: Feb. 12, 2015

(54) HEARING DEVICE SYSTEM

(71) Applicant: Otorix AB, 43654 Hovas (SE)

(72) Inventor: Patrik Westerkull, Askim (SE)

(73) Assignee: Otorix AB, 43654 Hovas (SE)

(21) Appl. No.: 14/283,445

(22) Filed: May 21, 2014

Related U.S. Application Data
(63) Continuation-in-part of application No. 14/250,618, filed on Apr. 11, 2014, now abandoned.
Application No. 14/250,618 is a continuation-in-part of application No. 14/017,593, filed on Sep. 4, 2013.
Application No. 14/017,593 is a continuation-in-part of application No. 13/963,186, filed on Aug. 9, 2013, now abandoned.

(51) Int. Cl. H04R 25/00; C09J 133/08

(52) U.S. Cl. CPC H04R 25/606; C09J 133/08; C09J 2433/00
USPC 381/322

(57) ABSTRACT

The hearing device system has features for preventing a hearing device from falling off from the user. The hearing device system has a safety line has a first portion connected to the hearing device and a second portion connected to an interconnection unit attached to the user. There is a coupling between the interconnection unit and the safety line that enables the user to connect and disconnect the safety line to and from the interconnection unit. The interconnection unit has an adhesive surface facing the skin so that it can be adhered to the skin of the user.

### PRIOR APPLICATION

This is a continuation-in-part application of U.S. patent application Ser. No. 14/250,618, filed 11 Apr. 2014 that is a continuation-in-part application of U.S. patent application Ser. No. 14/017,593, filed 4 Sep. 2013 that is a continuation-in-part application of U.S. patent application Ser. No. 13/963,186, filed 9 Aug. 2013.

### TECHNICAL FIELD

The present invention relates to a hearing device system.

### BACKGROUND OF THE INVENTION

Hearing devices, such as hearing aids and implantable hearing devices that include a microphone may be attached to the body in many different ways. They may, for example, be attached by an ear hook, through a magnetic attachment to an implanted part or with a coupling to, for example, a percutaneous implant connection. Since the hearing device should be easily removable there is also a risk that the device may fall off unintentionally in some situations and it may then break or it may be lost. Arrangements with a line that connects the hearing device with a safety pin or clip that is connected to the clothes or hair are the currently available solutions to this problem. However, these solutions have significant drawbacks since it is not practical to have the hearing device connected to the clothes via the line. Also, connections of the hearing device via the line to the hair may easily slip off. In spite of several efforts, this challenge has yet not found a good solution. There is a need for a solution where the hearing aid can be secured to the user in a robust way, and where the hearing device can still be easily removed by the user. The need for such an arrangement is increasing since more hearing devices are magnetically attached to the user and these types of devices have a tendency of falling off more easily. Such devices may, for example, be cochlear implants, bone conduction devices or middle ear devices. These types of devices are often more expensive since they often include implantable technologies where a magnet has been implanted under the skin for the attachment of the external hearing device portion. Hearing device here refers to the external portion of such a hearing system and not the implanted portion. It is usually not possible for these devices to increase the magnetic attachment force against the skin since this may cause skin irritation or even skin necrosis and therefore the external part of the hearing device may easily fall off.

There is a need for a more effective attachment system for hearing devices that is reliable and does not have the drawbacks discussed above.

### SUMMARY OF THE INVENTION

The present invention provides an effective solution to the above-outlined problems. More particularly, the hearing device system of the present invention has a safety line including a first connection portion. Furthermore, the hearing device system of the present invention has an interconnection unit that has a first side, having a second connection portion, and a second side that is at least partly provided with an adhesive component. The second side is configured to, when in use, face a skin of a user of the hearing device system. The first connection portion of the safety line is connectable to the second connection portion of the interconnection unit so that these two portions form a coupling. The present invention also allows the first connection portion of the safety line to be connected to and disconnected from the interconnection unit without having to, at the same time, connect or disconnect the interconnection unit to or from the skin of the user.

The hearing device system of the present invention may preferably configured so that the adhesive component is a separately arranged adhesive sheet that has a first adhesive surface being connectable to the second surface of the interconnection unit, and a second adhesive surface configured to, when in use, being connectable to the skin of the user of the hearing device system. This is an efficient way of manufacturing the adhesive component on the interconnection unit and may also enable and enhance the process of changing or replacing a worn out adhesive component of the interconnection unit to a new adhesive component.

Preferably, the interconnection unit has at least one through-hole defined therein that extends from the first side to the second side of the interconnecting unit. This allows for moisture and air transportation through the interconnection unit which is beneficial to the skin of the user to which the interconnection unit can be attached with the adhesive component. Preferably, the interconnection unit has several through-holes defined therein and the interconnection unit may also have a porous material for the same purpose.

In a preferred embodiment, the interconnection unit has a protective sheet disconnectably arranged on the adhesive component, such that the adhesive component is sandwiched between the protective sheet and the interconnection unit. The protective sheet protects the adhesive component during transportation.

Preferably, the second connection portion of the interconnection unit is a knob with a neck and the first connection portion of the safety line has a hole defined therein that has a wider portion and a more narrow portion so that the knob can be inserted into the wide portion of the hole but not into the narrow portion of the hole of the first connection portion. In this way, the neck can, preferably with a light snap, enter the narrow portion of the hole so that the first connection portion can be connected to the second connection portion without falling off.

The second connection portion is positioned non-centrically on the first side of the interconnection unit. The interconnection unit may preferably be attached to the naturally non-hair bearing area behind the ear of the user since the adhesive attachment of the interconnection unit would be less efficient on a hair bearing area. With the second connection portion being non-centrically positioned on the first side, towards a rear portion of the interconnection unit when the interconnection unit is attached to the skin behind the ear of a user, the first connection portion is positioned further back to the rear, i.e. further away from the outer ear which makes it more accessible and the second connection portion is, preferably, not positioned far into the fold behind the ear which may be beneficial from a comfort point of view.

Preferably, the adhesive of the adhesive surface of the adhesive component that is facing the skin of the user is an acrylate adhesive. This type of adhesive is very tolerant to moist conditions and is significantly more skin friendly that the old type of latex-based adhesives. The adhesive facing the skin of the user may also be silicone adhesive. This type of adhesive may be especially useful for very sensitive skin and may be optimal for some users. The silicone adhesive is less tolerant to moist conditions but when skin sensitivity is a priority this may be an optimal choice of adhesive. A hydrocolloid adhesive may also be used. This type of adhesive may be especially useful for some users and has specifically useful properties under moist conditions.

The adhesive that is facing the skin of the user may have UV (ultraviolet)-sensitive release-components so that the adhesive becomes UV-sensitive and so that the adhesiveness of the adhesive is significantly reduced when the adhesive is exposed to UV-light. In this way, the interconnection unit can be removed from the skin in a much more gentle way with significantly reduced tear-off forces on the skin by first exposing the adhesive to UV light before the interconnection unit is removed from the skin. The interconnection unit may be designed to be at least partly or sufficiently transparent to UV light. In a preferred embodiment, at least part of the first side of the interconnection unit has a removable UV protective sheet that can protect the UV sensitive adhesive from UV light from, for example, the sun light. The UV-protective sheet can be made as a sticker that is covering at least part of the first side of the interconnection unit. To remove the interconnection unit, the UV protective sheet is first removed from the interconnection unit and then, for example, a handheld UV light is used to expose the interconnection unit with UV light so that the UV light that passes through the interconnection unit and reaches the adhesive makes the adhesive weaker so that the interconnection unit can easier be removed from the skin.

The interconnection unit may also have a connection portion, here called a third connection portion, so that the hearing device can be connected to the interconnection portion. This may be an efficient design for a hearing device that is adhesively retained on the head of the user through an adhesive interconnection unit since then the same adhesive interconnection unit can be used for both retaining the hearing aid on the head of the user and at the same time the safety line can be connected to the same interconnection unit. If the hearing aid falls off from the interconnection unit, it can still be caught by the safety line connected to the interconnection unit.

The hearing device may be magnetically attached wherein the hearing device has a magnet so that it is magnetically attached to another magnet implanted under the skin surface of the user.

The present invention has several advantages because it prevents the hearing device from falling to the ground if it is accidentally disconnected from the user. The attachment system with an adhesive interconnection unit still allows the user to take the hearing aid device on and off without having to tear the adhesive off the skin.

The safety line device can easily be connected to and disconnected from the interconnection unit by disconnecting the first connection portion from the second connection portion.

The interconnection unit can easily be manufactured in various shapes, colors and sizes to fit different users.

Another advantage of the hearing device system of the present invention is that it enables the attachment of the interconnection unit to the skin to be a separate process from the connection procedure of the hearing device. The interconnection unit of the present invention that adheres to the skin can be changed at an interval that is suitable for the skin, which may be every night or it may, for example, be more seldom like every third day or once a week. The skin can then rest during a night when the interconnection unit is not attached.

The hearing device system of the present invention thus has a hearing device and a safety line having a first connection portion at a first end portion thereof. An interconnection unit has a first side having a second connection portion and a second side at least partly provided with an adhesive component. The second side is adhesively attached to the adhesive component that is adhesively attachable to a skin of a user. The first connection portion is connectable to the second connection portion. The safety line has a second end portion connected to the hearing device.

In an embodiment, the adhesive component is a separately arranged adhesive sheet that has a first adhesive surface connectable to the second side of the interconnection unit. A second adhesive surface is connectable to the skin of the user.

In an embodiment, the interconnection unit has at least one through hole defined therein extending from the first side to the second side of the interconnection unit.

In an embodiment, the interconnection unit has a protective sheet disconnectably arranged on the adhesive component such that the adhesive component is sandwiched between the protective sheet and the interconnection unit.

In an embodiment, the second connection portion is non-centrically positioned on the first side of the interconnection unit.

In an embodiment, the second connection portion is a knob with a neck and the first connection portion has a hole defined therein having a wider portion and a more narrow portion so that the knob is insertable into the wide portion of the hole but not into the narrow portion of the hole of the first connection portion. The neck is insertable into the narrow portion of the hole to connect the first connection portion to the second connection portion.

In an embodiment, the adhesive component has an acrylate adhesive facing the skin of the user.

In an embodiment, the adhesive component has a silicone adhesive facing the skin of the user.

In an embodiment, the adhesive component has a hydrocolloid adhesive facing the skin of the user.

In an embodiment, the adhesive component has a UV-sensitive release component of an adhesive facing the skin of the user. The interconnection unit is at least partly designed to allow at least some transmission of UV light through the interconnection unit.

In an embodiment, at least part of the first side of the interconnection unit has a removable UV protective sheet.

In an embodiment, the interconnection unit has a third connection portion to which the hearing device connectable so that both the hearing device and the safety line are connectable to the interconnection unit.

In an embodiment, the hearing device has a magnet and the hearing device is magnetically attached to another magnet implanted under the skin surface of the user.

As described above, the hearing device system of the present invention includes a unique combination of technologies and provides new solutions and several advantages that meet complex user requirements.

### BRIEF DESCRIPTION OF THE DRAWINGS

FIG. 1 is a perspective side view of the hearing device system of the present invention;

FIG. 2 is a perspective side view hearing device system of the present invention when it is connected to a user;

FIG. 3A is a side view of the interconnection unit of the present invention with an adhesive component and protective part separated from the interconnection unit;

FIG. 3B is a side view of the embodiment shown in FIG. 3A with the adhesive component and protective part attached to the interconnection unit;

FIG. 3C is a side view of the embodiment shown in FIG. 3B with the protective part partially removed;

FIG. 3D is a side view of the embodiment shown in FIG. 3C with the protective part fully removed and the embodiment attached to a skin portion of a user; and

FIG. 4 is a perspective side view of the hearing device system of the present invention, as shown in FIG. 2, with the hearing device and first connection portion disconnected from the user.

### DETAILED DESCRIPTION

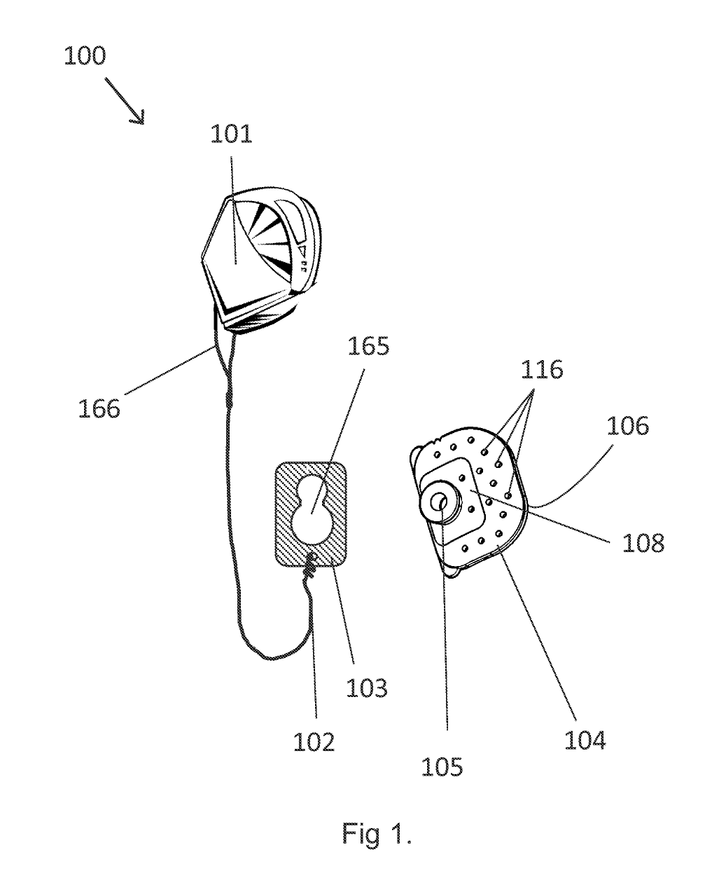

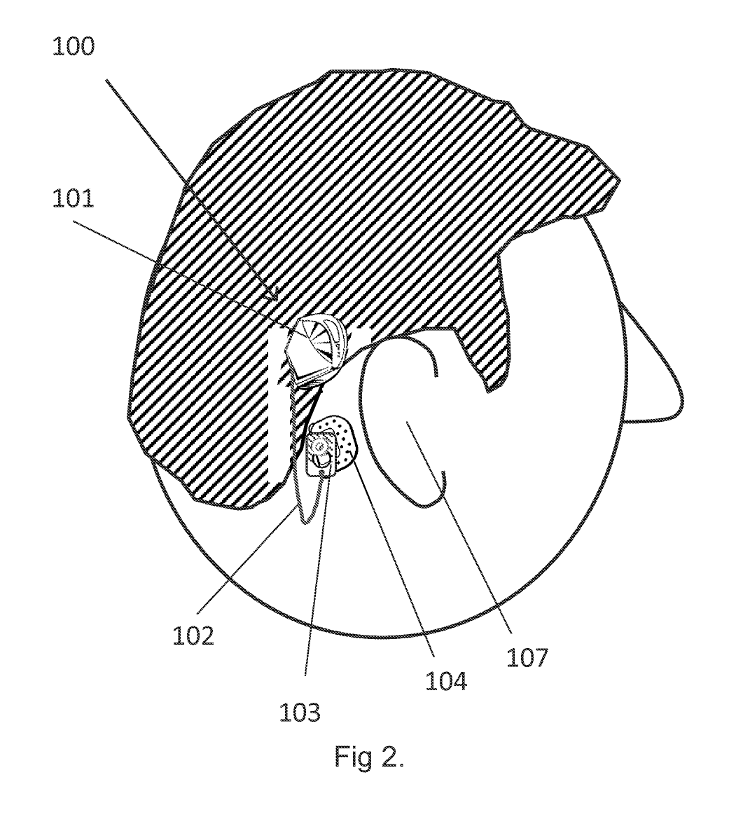

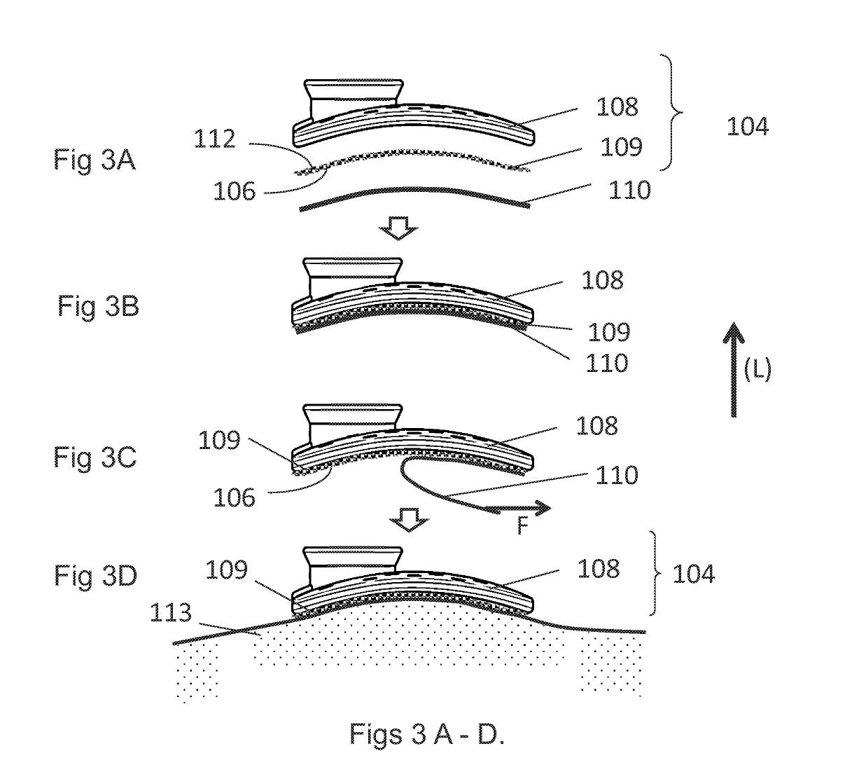

FIG. 1 is shows a hearing device system 100 of the present invention. A safety line 102 is connected to a first connection portion 103 and the other end of the line has a loop 166 attached to a hearing-aid device or hearing device 101 of the hearing device system 100. An interconnection unit 104 has a first side 108 and a second side 106 (not seen here) opposite to the first side 108. The first side 108 has a second connection portion 105 attached thereto. The first connection portion 103 and the second connection portion 105 form a coupling since they are connectable to each other. The first connection portion 103 has an eight-shaped hole 165 defined therein that is shaped to be connected to second connection portion 105. The second side 106 of the interconnection unit 104 has an adhesive component 109 attached (shown in FIGS. 3A-D) thereto. Preferably, the adhesive component 109 has adhesive surfaces on both sides so that it can be removably attached to the second surface 106 and to the skin of a user (best shown in FIG. 2). The first connection portion 103 can be removably connected to the second connection portion 105 of the interconnection unit 104. In this way, the user may easily remove a portion of the hearing device system 100 by disengaging the hearing device 101 and unhooking the first connection portion 103 from the interconnection unit 104 while the interconnection unit 104 remains attached to the skin of the user via the adhesive component 109. The interconnection unit 104 may for example be flexible to better follow the individual head curvature of the user.

Preferably, the interconnection unit 104 has a plurality of openings 116 defined therethrough so that air and moisture may be transported through the interconnection unit 104 to and from the patient's skin covered by the interconnection unit 104.

FIG. 2 is a perspective side overview hearing device system 100 of the present invention attached to a head of a user or patient. The hearing device 101 is connected via the safety line 102 to the first connection portion 103 that is connected to the interconnection unit 104 which, in turn, is connected with the adhesive surface of the adhesive component 109, attached to the second surface 106, to the skin behind the ear 107 of the user. If the hearing device 101 falls off the head of the user, it is caught by the safety line 102 that is adhesively attached to the user through the interconnection unit 104.

FIGS. 3A-3D are side views of the composition of the interconnection unit 104 (FIG. 3A and FIG. 3B) and the application (FIG. 3C and FIG. 3D) of the interconnection unit 104 of the hearing device system of the present invention. A lateral direction (L) has been marked. In FIG. 3A the following separated parts are shown before assembly in manufacturing: The interconnection unit 104 has the first side 108, the second side 106 and the adhesive component 109 that may be a double-sided adhesive sheet. A protective part 110 that is useful to protect a contra-lateral adhesive surface of the adhesive component 109 during transportation. A user-friendly feature is that the adhesive component (such as a double-sided adhesive sheet) 109 is adapted to be applied to the skin and that it may allow moisture to penetrate therethrough and to be resorbed by the adhesive sheet. It is also possible for the user to remove the interconnection unit 104 completely, for example, during night-time so that the skin is not permanently interfered with and can “breathe” and function normally when the patient does not need to use the interconnection unit 104. It may also be possible to configure the adhesive component 109 as an adhesive, such as glue, that is directly applied to the second side 106 instead of configuring it as a double-side adhesive sheet. However, the use of a double-sided adhesive sheet may be efficient in manufacturing when applying a contra-lateral adhesive surface of the adhesive component 109 to the second side 106. The protective part may be a polymer or paper sheet. The double-sided adhesive sheet or component 109 has a lateral adhesive surface 112 facing the second side 106. Instead of using an adhesive on the surface 112, it is also possible to use other removable attachment mechanisms such as Velcro or separate glue. Since the adhesive component 109 may be removably attached to the second side 106 it is also possible to change or replace the adhesive component 109 on the interconnection unit 104 when this is more cost efficient than replacing then entire interconnection unit 104 that includes a new adhesive component 109. In FIG. 3B, the parts shown in FIG. 3A have been assembled so that the double-sided adhesive component 109 has been adhered to the second side 106, and the protective part 110 has been attached to the other side of the double-sided adhesive component 109 so that the unit is ready for transportation. In FIG. 3C, the protective part 110 is removed from the double-sided adhesive component 109 by applying a force (F) to expose the contra-lateral adhesive surface. In FIG. 3D, the interconnection unit 104 with its double-sided adhesive component 109 has been adhesively attached to the skin 113 on a user while the surface 112 remains adhesively attached to the second surface 106 of the interconnection unit 104.

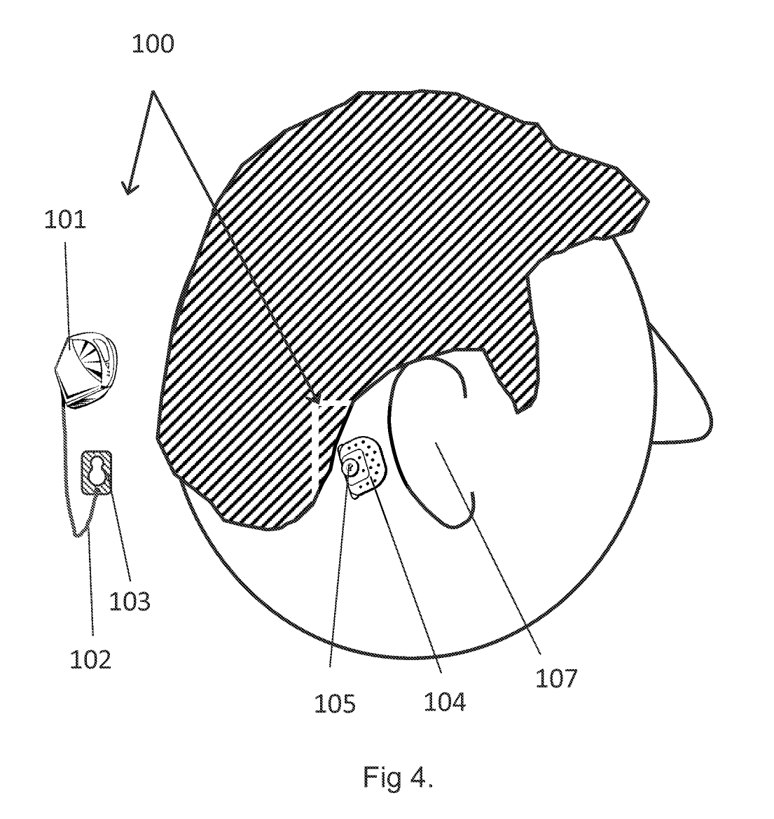

FIG. 4 is a perspective side overview of the hearing device system 100 of the present invention when the hearing device 101 and the first connection portion 103 have been disconnected from the user. The interconnection unit 104 remains connected with the adhesive component 109 to the skin behind the ear 107 of the user.

One important realization or feature of the present invention is that it is possible to use an adhesively attached interconnection unit between the safety line and the user. More particularly, the hearing device system of the present invention is preferably placed and adhered to the area of the skin behind the ear that does not have any hair growing thereon. It was unexpectedly realized that with modern skin adhesives it has been possible to solve the challenge of providing a good safety line attachment for hearing devices.

Another important feature is that the adherence is sufficiently strong so that the user can easily snap on and snap off the first connection portion 103, attached to the safety line 102, from the interconnection unit 104 without tearing off the interconnection unit 104 from the skin i.e. the interconnection unit 104 is sufficiently adhered to the skin by the adhesive component 109 so the unit 104 remains adhered to the skin while the user removes or disengages the first connection portion 103 from the second connection portion 105 of the interconnection unit 104. It is possible for the user to only attach the hearing aid device 101 and the safety line 102 to the interconnection unit 104 when necessary but also the user can easily remove the hearing device 101 therefrom without removing the interconnection unit 104 when needed such as when sleeping or swimming. The coupling between the safety line 102 and the interconnection unit 104 may be any suitable type of coupling like for example a snap, loop, Velcro, or hooks as long as it has the intended function. The safety line 102 may be designed by any suitable material in any suitable design and the connection to the hearing device 101 may be through a line loop or through any other arrangement or coupling.

The safety line 102 may also be designed as a flexible arm extending from the hearing device 101 to the interconnection unit 104. The flexible arm may, for example, be slightly bendable or equipped with joints. This may be a suitable design of the safety line 102 for some hearing devices.

For all of the above embodiments several alternative designs and combinations are possible and the invention is not limited to the preferred embodiments presented above. While the present invention has been described in accordance with preferred compositions and embodiments, it is to be understood that certain substitutions and alterations may be made thereto without departing from the spirit and scope of the following claims.

I claim:

1. A hearing device system, comprising,
a hearing device;
a safety line having a first connection portion at a first end portion thereof; and
an interconnection unit having a first side having a second connection portion and a second side at least partly provided with an adhesive component, the second side being adhesively attached to the adhesive component that is adhesively attachable to a skin of a user,
the first connection portion being connectable to the second connection portion; and
the safety line having a second end portion connected to the hearing device.

2. The hearing device system according to claim 1, wherein the adhesive component is a separately arranged adhesive sheet having a first adhesive surface being connectable to the second side of the interconnection unit, and a second adhesive surface being connectable to the skin of the user.

3. The hearing device system according to claim 1 wherein the interconnection unit has at least one through hole defined therein extending from the first side to the second side of the interconnection unit.

4. The hearing device system according to claim 1, wherein the interconnection unit has a protective sheet being disconnectably arranged on the adhesive component, such that the adhesive component is sandwiched between the protective sheet and the interconnection unit.

5. The hearing device system according to claim 1, wherein the second connection portion is non-centrically positioned on the first side of the interconnection unit.

6. The hearing device system according to claim 1 wherein the second connection portion is a knob with a neck and the first connection portion has a hole defined therein having a wider portion and a more narrow portion so that the knob is insertable into the wide portion of the hole but not into the narrow portion of the hole of the first connection portion, and wherein the neck insertable into the narrow portion of the hole to connect the first connection portion to the second connection portion.

7. The hearing device system according to claim 1, wherein the adhesive component has an acrylate adhesive facing the skin of the user.

8. The hearing device system according to claim 1, wherein the adhesive component has a silicone adhesive facing the skin of the user.

9. The hearing device system according to claim 1, wherein the adhesive component has a hydrocolloid adhesive facing the skin of the user.

10. The hearing device system according to claim 1, wherein the adhesive component has a UV-sensitive release component of an adhesive facing the skin of the user , and wherein the interconnection unit is at least partly designed to allow at least some transmission of UV light through the interconnection unit.

11. The hearing device system according to claim 10, wherein at least part of the first side of the interconnection unit has a removable UV protective sheet.

12. The hearing device system according to claim 1, wherein the interconnection unit a third connection portion to which the hearing device connectable so that both the hearing device and the safety line are connectable to the interconnection unit.

13. The hearing device system according to claim 1, wherein the hearing device has a magnet and, the hearing device is magnetically attached to another magnet implanted under the skin surface of the user.
